(19) United States
(12) Patent Application Publication
(10) Pub. No.: US 2011/0183881 A1
(43) Pub. Date: Jul. 28, 2011

(54) Laundry Detergent Bar Composition

(76) Inventor: Angelito Delos Reyes, Utrecht (NL)

(21) Appl. No.: 13/011,114

(22) Filed: Jan. 21, 2011

(30) Foreign Application Priority Data
Jan. 25, 2010 (SG) 201000525-4

(51) Int. Cl. C11D 3/37; C08F 222/02

(52) U.S. Cl. 510/361; 526/318.2

(57) ABSTRACT

The present invention relates to a non-phosphate laundry detergent bar composition having specific polycarboxylate compounds as builders instead of the traditional phosphate compound builders.

This patent application claims the benefit of the earlier filed Singapore Patent Application No. 201000525-4 filed on Jan. 25, 2010 under 37 CFR 1.55 (a).

The present invention relates to novel laundry detergent bar compositions. Specifically, the present invention relates to a laundry detergent bar composition having specific polycarboxylate compounds as builders instead of the traditional phosphate compound builders.

In many locales, laundry detergent bars are used for cleaning clothes. Technical developments in the field of laundry detergent bars have concerned formulating laundry detergent bars which are effective in cleaning clothes; which have acceptable sudsing characteristics in warm and cool water, and in hard and soft water; which have acceptable in-use wear rates, hardness, durability, and feel; which have low slough and rapid drying; and which have a pleasing odor and appearance.

Sodium tri-polyphosphate (STPP) has always been considered a good builder and structurant for laundry bar detergents. It helps in preventing breakage and quick dissolution of bars. It also contributes to the alkalinity, anti-redeposition and cleaning efficiency of bars. However, high concentration of STPP is not desirable due to environmental reasons, specifically, phosphate leakage to the sewage system which can lead to eutrophication. This causes excessive algal bloom, decreasing water quality and fish populations. Due to the mentioned disadvantages of STPP there is a need to lower the usage of STPP in the production of laundry bar detergents.

Polycarboxylates have been found to be an alternative to STPP. Though polycarboxylates are good anti-redeposition and sequestration agents, their uses in laundry bars have been limited as it is regarded that additional liquid will make it difficult to form laundry bars by extrusion. WO 00/040691 discloses a phosphate-free laundry bar composition which incorporates polycarboxylates into the composition. The problem with WO 00/040691, however is that the reference does not disclose laundry detergents that are free of phosphates but merely discloses those that are “substantially free.” Moreover, the reference does not lead one to select the particular class of polycarboxylates that yield improved performance over the general class of compounds. Lastly, polycarboxylates are mentioned as an aside in the reference; the reference's primarily focus is teaching the use of STPP as a builder.

Accordingly, the need remains for a laundry detergent bar having acceptable in-use wear rates, hardness, durability, rapid drying, and low smear that is more eco-friendly.

The present invention solves this problem by providing STPP-free laundry bars using specific polycarboxylates as the builder which could form, harden and have a decrease dissolution rate compared to STPP-built bar detergents.

The present invention provides a laundry detergent bar composition for washing fabrics comprising a composition having a functionalized polycarboxylate wherein the composition is free of phosphate.

All percentages, ratios and proportions herein are by weight of the laundry detergent bar, unless otherwise specified. All temperatures are in degrees Celsius (° C.) unless otherwise specified. All documents cited are incorporated herein by reference.

The term “linear” as used herein, with respect to LAB and/or LAS, indicates that the alkyl portions thereof contain less than about 30%, alternatively less than bout 20%, more alternatively less than about 10% branched alkyl chains.

The term “substantially free” as used herein indicates that the impurities contained in the laundry detergent bar of the present invention are insufficient to contribute positively or negatively to the cleaning effectiveness of the composition. The laundry detergent bar of the present invention contains, by weight, less than about 5%, alternatively less than about 2%, and more alternatively less than about 0.5% of the indicated material.

The term “laundry bar” as used herein is a laundry detergent in solid state that is useful for cleaning textiles and nonwovens. Laundry bars may be solid bars, powders or individual pellets or other solid state configurations. Laundry bars of the present invention are comprised of specific dispersant builders. Laundry bars of the present invention are free of phosphate.

The laundry bars of the present invention comprise a builder capable of sequestering heavy metal ions in the wash water, in order to aid the clothes washing process. Surprisingly, it has been found that suitable builders in the present bars are specific non-phosphate functionalized polycarboxylate builders. Such polycarboxylate builders are typically presented as salts in the laundry bar composition. Such polycarboxylate builders are polymeric wherein the composition comprises i) one or more (C₃-C₆) monoethylenically unsaturated carboxylic acids ranging in an amount from 30-100 weight percent based upon the total weight of the polycarboxylate builder; ii) one or more (C₄-C₈) monoethylenically unsaturated dicarboxylic acids in an amount ranging from 0-70 weight %; iii) a monomer selected from one or more (C₁-C₁₂) alkyl methacrylates in an amount ranging from 0-20 weight %; and iv) a monomer selected from one or more unsaturated monomer which is copolymerizable with the monomers in (i), (ii) and (iii) in an amount from 0-30 weight %. The foregoing optional components of the polycarboxylate builder may be present in alone in various combinations with each other or absent in total in the composition.

Examples of suitable polycarboxylate salts are typically derived from low molecular weight (MW) about 1500-10,000, alternatively from 2000-7000, polyacrylic acid homopolymer (PAA) or its co-polymer with maleic anhydride (PAA-MA), poly(methacrylic acid), or poly(acrylic acid-co-methacrylic acid), which is neutralized with alkali metal hydroxide, alkali metal carbonate, alkali metal bicarbonate, or neutralized with an organic base such as tetramethyl ammonium hydroxide, amines such as aliphatic amines, alkanolamines, or mixtures thereof. The polycarboxylates of the present invention have a phosphono functional end group. The present bars comprise from 1% to about 20% builder, alternatively from about 1% to about 10%, more alternatively from about 1% to about 5% builder.

Laundry bars of the present invention additionally comprise from about 20% to about 70% surfactant, alternatively from about 25% to about 65% surfactant, more alternatively from about 30% to about 60% surfactant. The surfactant in the present invention laundry bars comprises from about 50% to 100% soap, alternatively from about 60% to about 90% soap, more alternatively from about 65% to about 85% soap. The surfactant in the present invention bars comprises from 0% to about 50% alkylbenzene sulfonate, alternatively from about 10% to about 40% alkylbenzene sulfonate, more alternatively from about 15% to about 35% alkylbenzene sulfonate. Alternatively the surfactant of the present invention laundry bars consists essentially of soap and alkylbenzene sulfonate.

As used herein, “soap” means salts of fatty acids. The fatty acids are straight or branch chain containing from about 8 to about 24 carbon atoms, alternatively from about 10 to about 20 carbon atoms. The average carbon chain length for the fatty acid soaps is from 12 to 18 carbon atoms, alternatively from 14 to 16 carbon atoms. Non-limiting examples of salts of the fatty acids are alkali metal salts, such as sodium and potassium, especially sodium. Other examples of salts include ammonium and alkylolammonium salts.

The fatty acids of soaps useful in the present invention bars are alternatively obtained from natural sources such as plant or animal esters; examples include coconut oil, palm oil, palm kernel oil, olive oil, peanut oil, corn oil, sesame oil, rice bran oil, cottonseed oil, babassu oil, soybean oil, castor oil, tallow, whale oil, fish oil, grease, lard, and mixtures thereof. Suitable fatty acids are obtained from coconut oil, tallow, palm oil (palm stearin oil), palm kernel oil, and mixtures thereof. Fatty acids can be synthetically prepared, for example, by the oxidation of petroleum, or by hydrogenation of carbon monoxide.

Alkali metal soaps can be made by direct saponification of the fats and oils or by the neutralization of the free fatty acids which are prepared in a separate manufacturing process. Particularly useful are the sodium and potassium salts of the mixtures of fatty acids derived from coconut oil and tallow, i.e., sodium and potassium tallow and coconut soaps.

The term “tallow” is used herein in connection with materials with fatty acid mixtures which typically have a carbon chain length distribution comprised of saturated C₁₄, C₁₆, and C₁₈ alkyl chains, monosaturated fatty acids (palmitoleic and oleic) and polyunsaturated fatty acids (linoleic and linolenic). Other fatty acids, such as those from palm oil and those derived from various animal tallows and lard, are also included within the term tallow. The tallow can also be hardened (i.e., hydrogenated) to convert part or all of the unsaturated fatty acid moieties to saturated fatty acid moieties.

Suitable soap raw materials for the present invention are neat soaps made by kettle (batch) or continuous saponification. Neat soaps typically comprise from about 65% to about 75%, alternatively from about 67% to about 72%, alkali metal soap; from about 24% to about 34%, alternatively from about 27% to about 32%, water; and minor amounts, alternatively less than about 1% total, of residual materials and impurities, such as alkali metal chlorides, alkali metal hydroxides, alkali metal carbonates, glycerin, and free fatty acids. Another Suitable soap raw material is soap noodles or flakes, which are typically neat soap which has been dried to a water content of from about 10% to about 20%. The other components above are proportionally concentrated.

As used herein, alkylbenzene sulfonates means salts of alkylbenzene sulfonic acid with an alkyl portion which is straight chain or branch chain, alternatively having from about 8 to about 18 carbon atoms, more alternatively from about 10 to about 16 carbon atoms. The alkyl chains of the alkylbenzene sulfonic acid alternatively have an average chain length of from about 11 to about 14 carbon atoms. Branched chain or mixed branched and straight chain alkylbenzene sulfonates are known as ABS. Straight chain alkylbenzene sulfonates, known as LAS, are more biodegradable than ABS. The acid forms of ABS and LAS are referred to herein as HABS and HLAS, respectively.

The salts of the alkylbenzene sulfonic acids are alternatively the alkali metal salts, such as sodium and potassium, especially sodium. Salts of the alkylbenzene sulfonic acids also include ammonium.

Alkylbenzene sulfonates and processes for making them are disclosed in U.S. Pat. Nos. 2,220,099 and 2,477,383, incorporated herein by reference.

While alkylbenzene sulfonates help to impart good cleaning performance in laundry bars, it has been found that they also tend to cause an undesired softness of the bars.

The water content of the laundry bars of the present invention generally depends on the amount of soap in the bar, since much of the water enters the present process with the soap raw material. Water is also often added in the process for making the present invention bars to facilitate processing of the bars. Typically, such water is added to facilitate mixing and/or reaction of the materials. When HLAS or HABS are added and are to be neutralized by alkali metal carbonate, water is alternatively added to aid dissolution of the carbonate and its reaction with the alkylbenzene sulfonic acid. Materials incorporated in the bars may be added in aqueous solution in order to facilitate distribution of the material in the bars. In particular, sulfate salts, or at least a portion of them, are alternatively incorporated in the bars by the addition of aqueous solutions of them.

The water content of the laundry bars of the present invention is from about 0.1% to about 10%, alternatively from about 2% to about 10%, more alternatively from about 4% to about 8%, more alternatively still from about 6% to about 8%.

When alkylbenzene sulfonate surfactant is incorporated in the present development bars, the corresponding alkylbenzene sulfonic acid is alternatively used as a raw material. The acid is typically neutralized during the process of making the bars in a mixing step. Alkali metal carbonates are typically used as the neutralizing material. Suitable alkali metal carbonates are sodium and potassium carbonates, especially sodium carbonate. In prior art processes for making bars with alkylbenzene sulfonates, a small excess of alkali metal carbonate is typically incorporated in such bars to ensure complete neutralization of the acid.

A water-soluble inorganic strong-electrolyte salt may be used in the composition of the present invention, in an amount sufficient to achieve a minimum electrolyte content. As used herein, “strong-electrolyte salt” excludes carbonates, bicarbonates, builders, and other inorganic materials disclosed herein as present bar components, but which are water-soluble inorganic weak electrolyte salts. Suitable water-soluble inorganic strong-electrolyte salts suitable for incorporation in the present invention bars include the alkali metal, alternatively sodium and potassium, sulfates and halides, alternatively chlorides, and mixtures thereof. Particularly suitable salts include sodium sulfate and sodium chloride, and mixtures thereof. Sodium sulfate is particularly suitable because it is less corrosive to equipment than sodium chloride. The amount of such salts incorporated in the present bars is from about 2% to about 20%, alternatively from about 2% to about 15%, more alternatively from about 3% to about 10%, more alternatively still from about 4% to about 8%.

An optional ingredient for incorporation in the present invention laundry bars is starch. Starch helps provide additional firmness for such bars. Suitable starches for incorporation in the bars include whole-cut corn starch, tapioca-type starches, and other starches with similar properties and which are not pregelatinized, collectively referred to herein as “whole-cut” starches. Starch is typically incorporated into the composition in an amount from 0% to about 4%, alternatively from about 1% to about 3%.

Starch derivatives such as pregelatinized starches, amylopectins, and dextrins, referred to herein as “other starches”, can also be used to give the bars of the present invention some additional firmness and particular physical properties, as described in U.S. Pat. No. 4,100,097. The amount of other starches incorporated in the present bars is from 0% to about 10%.

The incorporation of a high level of alkali metal carbonate in the present invention bars results in a high pH wash solution, when the bar is used to wash clothes. Such high pH wash solution can be harsh to human skin. Such harshness can be reduced by incorporating an alkali metal bicarbonate in the present invention bars, in addition to the residual bicarbonate mentioned above. Such alkali metal bicarbonates include sodium bicarbonate and potassium bicarbonate, especially sodium bicarbonate. The amount of additional alkali metal bicarbonate incorporated in the present bars is from 0% to about 8% (bar weight basis), alternatively from about 0.5% to about 5%, more alternatively from about 1% to about 4%.

The pH of a 1% aqueous solution of a bar composition of the present invention is alternatively from about 9.5 to about 10.8, more alternatively from about 10.0 to about 10.5.

The present invention laundry bars may also contain water-insoluble fillers, such as kaolinite, talc, and calcium carbonate. Clays, such as bentonite are used as fillers, but also provide some fabric softening benefit. Because some sulfates, such as sodium sulfate, are sparingly soluble in water, a large excess of such sulfate (over that which helps provide increased firmness for the bars, as disclosed hereinabove) can essentially be considered a water-insoluble filler. The amount of such insoluble fillers in the present invention bars is from 0% to about 40%, alternatively from about 5% to about 30%.

The present invention laundry bars may contain other optional ingredients. Such other ingredients include other non-phosphate builders, such as aluminosilicates (especially zeolites), silicates, and citrates; chelants; enzymes, such as cellulase, lipase, amylase, and protease; soil release polymers; dye transfer inhibiting agents; fabrics softeners such as clays and quaternary ammonium compounds; bleaching agents; gums; thickeners; binding agents; soil suspending agents; optical brighteners; colorants and opacifiers such as titanium dioxide; bluing agents; perfumes. The amount of such other ingredients in the present invention bars is from 0% to about 15%, alternatively from about 1% to about 5%.

When manufacturing the laundry bars, typical process known to those skilled in the art are employed. The elements of the composition are mixed together. Typical mixers used in mixing the composition include but are not limited to ribbon mixers, sigma-type mixers, soap amalgamators, and plow-type mixers (such as made by Littleford or by Loedige). Such mixers are water-jacketed for temperature control in the mixer, if necessary.

The mixture from the mixer (at about 50° C. to about 70° C.) is alternatively fed through roll mills to provide more intimate mixing of the materials in the mixture. Roll mills used for this purpose are those typical of soap milling processes. Three-roll to five-roll mills are commonly used. The mill rolls are alternatively water cooled internally by ambient temperature water or a lower temperature refrigerant. Milling occurs by passing the largely solidified but still plastic mixture between the series of rotating rolls, successive members of the series rotating at higher speeds and closer clearances, the mixture being thus presented to mechanical working, shearing, and compacting. The product emerges from the roll mills as flakes, or sheets which are broken into flakes.

The milling helps to eliminate speckling in the bars, which can occur due to incomplete mixing of the ingredients. The milling can also modify the crystalline phase of the soap making it more consistent and hard. It is suitable, but not required, that the soap be primarily in beta crystalline phase after milling.

The milled or mixed product is then typically plodded (extruded) using standard bar-making equipment and well-known methods to produce an elongated, cohered product which is then cut and shaped into bars using standard, well-known equipment and methods. Plodding of the flakes is alternatively carried out in a dual stage plodder that allows use of a vacuum. The plodding is alternatively carried out in the plodder at a temperature sufficient to produce an extruded solid having a temperature alternatively in the range of from about 40° C. to about 50° C. It is suitable that the extruder head be maintained at a temperature of from about 60° C. to about 80° C. A vacuum of about 40 cm Hg or greater is alternatively applied to the intermediate plodder chamber; this helps provide improved binding and a smooth finish on the surface of the plodded product.

### EXAMPLE

### Test Conditions

The test conditions were as follows: samples of cotton interlock were washed with 1.33 g/L of powder detergent (formulations Table I below) at a temperature of 30° C. for 3 cycles; at an agitation speed of 60 rpm. There was one 12 min. wash cycle and two 3 min. rinse cycles in a Terg-o-meter with 1000 ml of water. The fabric was soiled with a clay/oil dispersion containing 5 mL soil@24% clay=6.47 g wet; 1.747 g dry (1.553 g clay/0.194 g oil) with 100 ppm hardness as CaCO₃. Table 2 describes additional laundry bar formula compositions envisioned by the present invention. The results from the compositions of Table 1 are listed in Table 3 below.

TABLE 1
Formulation of laundry bar detergents

| Raw Materials | Sample A | Sample B | Sample C | Sample D | Sample E | Sample F | Sample G | Sample H | Sample I | Sample J |
|---|---|---|---|---|---|---|---|---|---|---|
| Soda Ash Light | 10 | 10.15 | 10.1 | 10.15 | 10.1 | 10.15 | 10.1 | 10.15 | 10.1 | 10.15 |
| LAS | 14 | 14.21 | 14.14 | 14.21 | 14.14 | 14.21 | 14.14 | 14.21 | 14.14 | 14.21 |
| Heavy CaCO3 | 31 | 31.47 | 31.31 | 31.47 | 31.31 | 31.47 | 31.31 | 31.47 | 31.31 | 31.47 |
| CFAS | 3.5 | 3.55 | 3.54 | 3.55 | 3.54 | 3.55 | 3.54 | 3.55 | 3.54 | 3.55 |
| STPP | 0 | 0 | 0 | 0 | 0 | 0 | 0 | 0 | 0 | 0 |
| Sodium Silicate | 10 | 10.15 | 10.1 | 10.15 | 10.1 | 10.15 | 10.1 | 10.15 | 10.1 | 10.15 |
| 90% acrylic acid/ | 2 | 3.05 | | | | | | | | |
| 10% maleic acid | | | | | | | | | | |
| with phosphono | | | | | | | | | | |
| end group (50%) | | | | | | | | | | |
| 70% Acrylic acid: | | | 2.02 | 3.05 | | | | | | |
| 30% maleic acid | | | | | | | | | | |
| (40%) | | | | | | | | | | |
| 90% acrylic acid/ | | | | | 2.02 | 3.05 | | | | |
| 10% maleic acid | | | | | | | | | | |
| with sulfonated | | | | | | | | | | |
| end group (50%) | | | | | | | | | | |
| 100% acrylic acid | | | | | | | 2.02 | 3.05 | | |
| with phosphono | | | | | | | | | | |
| end group (40%) | | | | | | | | | | |
| 100% acrylic acid | | | | | | | | | 2.02 | 3.05 |
| with phosphono | | | | | | | | | | |
| end group (50%) | | | | | | | | | | |
| Sodium Sulfate | 10 | 10.15 | 10.1 | 10.15 | 10.1 | 10.15 | 10.1 | 10.15 | 10.1 | 10.15 |
| Kaolin | 13 | 13.2 | 13.13 | 13.2 | 13.13 | 13.2 | 13.13 | 13.2 | 13.13 | 13.2 |
| Colored Dye | 0.05 | 0.05 | 0.05 | 0.05 | 0.05 | 0.05 | 0.05 | 0.05 | 0.05 | 0.05 |
| Perfume | 0.35 | 0.36 | 0.35 | 0.36 | 0.35 | 0.36 | 0.35 | 0.36 | 0.35 | 0.36 |
| Water | 5.1 | 3.65 | 4.14 | 3.65 | 4.14 | 3.65 | 4.14 | 3.65 | 4.14 | 3.65 |

TABLE 2
Formulation of laundry bar detergents (compositional variability)

| | Sample | | | | | | | | | |
|---|---|---|---|---|---|---|---|---|---|---|
| Raw Materials | K | Sample L | Sample M | Sample N | Sample O | Sample P | Sample Q | Sample R | Sample S | Sample T |
| Soda Ash Light | 10 | 10 | 10 | 10 | 10 | 10 | 10 | 10 | 10 | 10 |
| LAS | 15 | 15 | 15 | 15 | 15 | 15 | 15 | 15 | 15 | 15 |
| Heavy CaCO₃ | 30 | 30 | 30 | 30 | 30 | 30 | 30 | 30 | 30 | 30 |
| CFAS | 3.5 | 3.5 | 3.5 | 3.5 | 3.5 | 3.5 | 3.5 | 3.5 | 3.5 | 3.5 |
| STPP | 0 | 0 | 0 | 0 | 0 | 0 | 0 | 0 | 0 | 0 |
| Sodium Silicate | 10 | 10 | 10 | 10 | 10 | 10 | 10 | 10 | 10 | 10 |
| 90% acrylic acid/ | 1 | 5 | 10 | | | | | | | |
| 10% maleic acid | | | | | | | | | | |
| with phosphono | | | | | | | | | | |
| end group (50%) | | | | | | | | | | |
| 100% acrylic acid | | | | 1 | 5 | 10 | | | | |
| with sulfonate end | | | | | | | | | | |
| group (45%) | | | | | | | | | | |
| 100% acrylic acid | | | | | | | 1 | 5 | 10 | |
| with phosphino end | | | | | | | | | | |
| group (42%) | | | | | | | | | | |
| Sodium Sulfate | 10 | 10 | 10 | 10 | 10 | 10 | 10 | 10 | 10 | 10 |
| Kaolin | 15 | 11 | 6 | 15 | 11 | 6 | 15 | 11 | 6 | 16 |
| Colored Dye | 0.05 | 0.05 | 0.05 | 0.05 | 0.05 | 0.05 | 0.05 | 0.05 | 0.05 | 0.05 |
| Perfume | 0.35 | 0.35 | 0.35 | 0.35 | 0.35 | 0.35 | 0.35 | 0.35 | 0.35 | 0.35 |
| Water | 5.1 | 5.1 | 5.1 | 5.1 | 5.1 | 5.1 | 5.1 | 5.1 | 5.1 | 5.1 |
| (Balance to 100%) | | | | | | | | | | |

TABLE 3
ANTI SOIL REDEPOSITION TEST RESULT
(Clay/Oil Dispersion at 100 ppm)

| | Clay/Oil (8:1) Dispersion | | |
|---|---|---|---|
| | Cotton Interlock Knit (Knit Cotton) | | |
| | Mean | Mean | Mean DELTA |
| | REFLECTANCE (Y) | REFLECTANCE (Y) | REFLECTANCE |
| | BEFORE WASH | AFTER WASH | (ΔY) |
| Bar A (2% 90% acrylic acid/ | 94.08 | 89.68 | 4.40 |
| 10% maleic acid with | | | |
| phosphono end group/1% | | | |
| STPP) | | | |
| Bar B (3% 90% acrylic acid/ | 93.94 | 90.11 | 3.83 |
| 10% maleic acid with | | | |
| phosphono end group) | | | |
| Bar C (2% 70% Acrylic acid: | 94.17 | 89.20 | 4.97 |
| 30% maleic acid/1% STPP) | | | |
| Bar D (3% 70% Acrylic acid: | 94.02 | 89.45 | 4.57 |
| 30% maleic acid) | | | |
| Bar E (2% 90% acrylic acid/ | 93.80 | 89.84 | 3.96 |
| 10% maleic acid with | | | |
| sulfonated end group/1% | | | |
| STPP) | | | |
| Bar F (3% 90% acrylic acid/ | 94.16 | 88.90 | 5.26 |
| 10% maleic acid with | | | |
| sulfonated end group) | | | |
| Bar G (2% 100% acrylic acid | 94.12 | 89.97 | 4.15 |
| with phosphono end group/ | | | |
| 1% STPP) | | | |
| Bar H (3% 100% acrylic acid | 94.12 | 89.78 | 4.34 |
| with phosphono end group) | | | |
| Bar I (2% 100% acrylic | 94.19 | 89.76 | 4.43 |
| acid with phosphono end | | | |
| group/1% STPP) | | | |
| Bar J (3% 100% acrylic acid | 94.23 | 89.86 | 4.37 |
| with phophono end group) | | | |
| PGM | 94.19 | 89.96 | 4.23 |
| PGT | 94.22 | 89.64 | 4.58 |

Note:
Lower DELTA REFLECTANCE (ΔY) denotes better anti redeposition property against clay/oil.
Result summary Clay/oil Anti-redepostion: B > E > G > H > J > A > I > D > C > F

The bar detergents without STPP and a higher percentage of homopolymer or copolymer dispersant, B, J, H with the functional end group were generally better in performance than the rest of the bar detergents. It is also interesting to note that lower amount of functionalized dispersant with phosphate builder performed well in comparison to homopolymer or copolymers without functionalization.

What is claimed is:

1. A laundry bar composition for washing fabrics comprising
a functionalized polycarboxylate builder;
wherein the laundry bar composition is free of phosphates.

2. The laundry bar composition according to claim 1 wherein the polycarboxylate builder comprises
from 30-100 weight percent of one or more (C₃-C₆) monoethylenically unsaturated carboxylic acids;
ii. 0-70 weight percent of one or more (C₄-C₈) monoethylenically unsaturated dicarboxylic;
iii. 0-20 weight percent of a monomer selected from one or more (C₁-C₁₂) alkyl methacrylates; and
0-30 weight percent of a monomer selected from one or more unsaturated monomer which is copolymerizable with the monomers in (i), (ii) and (iii).

3. The detergent bar composition according to claim 1, comprising from 1% to about 30% by weight of functionalized polycarboxylate.

4. The detergent bar composition according to claim 1, comprising from 2% to about 20% by weight of functionalized polycarboxylate.

5. The detergent bar composition according to claim 1, wherein the functionalized polycarboxylate has an acrylic acid homopolymer base.

6. The detergent bar composition according to claim 1, wherein the functionalized polycarboxylate has an acrylic acid copolymer base.

7. The detergent bar composition according to claim 1, wherein the polycarboxylate is functionalized with a phosphono end group.

8. The detergent bar composition according to claim 1, wherein the polycarboxylate has a MW of 1500-10000.

9. The detergent bar composition according to claim 1, wherein the polycarboxylate is an acrylic acid/maleic acid copolymer.

10. The detergent bar composition according to claim 1, comprising a pH from 9.5 to 10.8.
